(19) United States
(12) Patent Application Publication
(10) Pub. No.: US 2019/0312966 A1
(43) Pub. Date: Oct. 10, 2019

(54) METHODS AND SYSTEMS FOR FACILITATING AUTOMATED CONTACT WITH EMERGENCY SERVICES IN CASE OF AN EMERGENCY

(71) Applicants: Soonbum Shin, Irvine, CA (US); Gene Shin, Irvine, CA (US)

(72) Inventors: Soonbum Shin, Irvine, CA (US); Gene Shin, Irvine, CA (US)

(21) Appl. No.: 16/375,382

(22) Filed: Apr. 4, 2019

Related U.S. Application Data
(60) Provisional application No. 62/652,797, filed on Apr. 4, 2018.

(51) Int. Cl. H04M 1/725; H04W 4/90; H04W 76/50

(52) U.S. Cl. CPC H04M 1/72538; H04M 1/72541; H04W 76/50; H04W 4/90

(57) ABSTRACT

Further disclosed herein is a system for facilitating automated contact with emergency services in case of an emergency, in accordance with some embodiments. Accordingly, the system may include a communication device configured for receiving at least one of an emergency indicator, and a distress input from a first user device. Further, the communication device may be configured for transmitting a request to a second user device for initiating communication with at least one emergency contact. Further, the system may include a processing device configured for analyzing the at least one of the emergency indicator, and the distress input to determine an emergency situation.

The current application claims a priority to the U.S. Provisional Patent application Ser. No. 62/652,797 filed on Apr. 4, 2018.

### TECHNICAL FIELD

Generally, the present disclosure relates to the field of data processing. More specifically, the present disclosure relates to methods, systems, apparatuses and devices for facilitating automated contact with emergency services in case of an emergency.

### BACKGROUND

Conventional method of making a call is by pushing the call button of the phone after entering the phone number to call or selecting name from the contact list. Sending text message also needs to access to the keypad in the phone. These methods of making a call or sending the text message is not a problem for regular people under normal circumstance. But for older people, who sustained injury after fall due to chronic health conditions, such as stroke, heart disease or dementia, may not have the phone nearby or may not be able to make the necessary call or texting to get immediate help.

One in four Americans aged 65+ falls each year. About 30-50% of falls in the elderly result in minor injuries, but an estimated 10% of falls in seniors cause major injuries, including intracranial injuries and fractures. As the number of Americans ages 65 and older is projected to more than double from 46 million today to over 98 million by 2060, the injuries from falls among seniors will also increase dramatically. It is necessary to provide immediate help to fallen seniors with effective communications, which will minimize the time-to-hospital to receive proper medical attention timely manner. While there are various types of phones are available for elderly use, injured seniors may not be able to make the emergency call when they can't move. It is apparent that a need exists for a technique whereby an injured senior is able to send the help message or make a call to get help.

Therefore, there is a need for improved methods, systems, apparatuses and devices for facilitating automated contact with emergency services in case of an emergency that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating automated contact with emergency services in case of an emergency, in accordance with some embodiments. Accordingly, the method may include a step of receiving, using a communication device, at least one of an emergency indicator, and a distress input from a first user device. Further, the method may include a step of analyzing, using a processing device, the at least one of the emergency indicator, and the distress input to determine an emergency situation. Further, the method may include a step of transmitting, using the communication device, a request to a second user device for initiating communication with at least one emergency contact associated with the user based on the analyzing.

Further disclosed herein is a system for facilitating automated contact with emergency services in case of an emergency, in accordance with some embodiments. Accordingly, the system may include a communication device configured for receiving at least one of an emergency indicator, and a distress input from a first user device. Further, the communication device may be configured for transmitting a request to a second user device for initiating communication with at least one emergency contact. Further, the system may include a processing device configured for analyzing the at least one of the emergency indicator, and the distress input to determine an emergency situation.

Further disclosed herein is a system to facilitate making a call from a phone to a pre-programmed number in response to at least one of tapping and knocking of a wristband paired with the phone in case of an emergency, in accordance with some embodiments. Further, the system may include a communication device configured for receiving indication of the at least one of the tapping and the knocking from the paired wristband. Further, the communication device may be configured for transmitting a request to the phone, wherein the request comprises making the call to the pre-programmed number.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system to facilitate automated contact with emergency services in case of an emergency, in accordance with some embodiments.

FIG. 3 is a flowchart of a method to facilitate automated contact with emergency services in case of an emergency, in accordance with some embodiments.

FIG. 4 is a flowchart of a method to facilitate automated communication with a second emergency contact, in accordance with some embodiments.

FIG. 5 is a flowchart of a method to facilitate receiving a pre-recorded message, in accordance with some embodiments.

FIG. 6 is a flowchart of a method to facilitate transmitting the pre-recorded message to the at least one emergency contact, in accordance with some embodiments.

FIG. 7 is a flowchart of a method to facilitate receiving a sensory data associated with the pre-recorded message, in accordance with some embodiments.

FIG. 8 is a system to facilitate making a call from a phone to a pre-programmed number in response to at least one of tapping and knocking of a wristband paired with the phone in case of an emergency, in accordance with some embodiments.

FIG. 9 is an exemplary representation of a system to facilitate automated contact with emergency services in case of an emergency.

FIG. 10 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of automated contact with emergency services in case of an emergency, embodiments of the present disclosure are not limited to use only in this context.

Overview:

As the elderly population grows rapidly, the injuries and medical cost from the falls among seniors become major concern for the family and society. It is important to minimize the time-to-hospital for injured seniors to receive proper medical attention timely manner. This disclosure relates to a method and system to make emergency cellular communications possible by tapping the smart wristband paired with a phone when the phone is not reachable or the caller is not in condition to make phone call in normal way to get necessary help. Particularly, the disclosure describes a practical solution to seniors as the method and system may be realized by making use of low cost wearables and phones in their regular use.

Further, in accordance with some embodiments, a method and a system to make a call to the preprogrammed phone number by tapping or knocking the paired wristband is disclosed.

Further, in accordance with some embodiments, a method and a system to change the phone setting to speaker phone mode when initiating the call by tapping or knocking the paired wristband and announcing the call initiation is disclosed.

Further, in accordance with some embodiments, a method and a system to send the text message to the preprogrammed phone number by tapping or knocking smart wristband paired with phone is disclosed.

Further, in accordance with some embodiments, a method and a system to convert preprogramming of text message for caller's name, location and the situation of the caller to voice message for 911 dispatcher, who can't receive the text message is disclosed.

Further, in accordance with some embodiments, a method for making a call to the preprogrammed phone number by tapping or knocking the smartwatch with phone capability is disclosed.

Further, in accordance with some embodiments, a method for sending text message to the preprogrammed phone number by tapping or knocking the smartwatch with phone capability is disclosed.

Further, in accordance with some embodiments, a method and a system for phone to send a vibration signal to the paired wristband to confirm its successful transmission of the text message to the preprogrammed phone number is disclosed.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

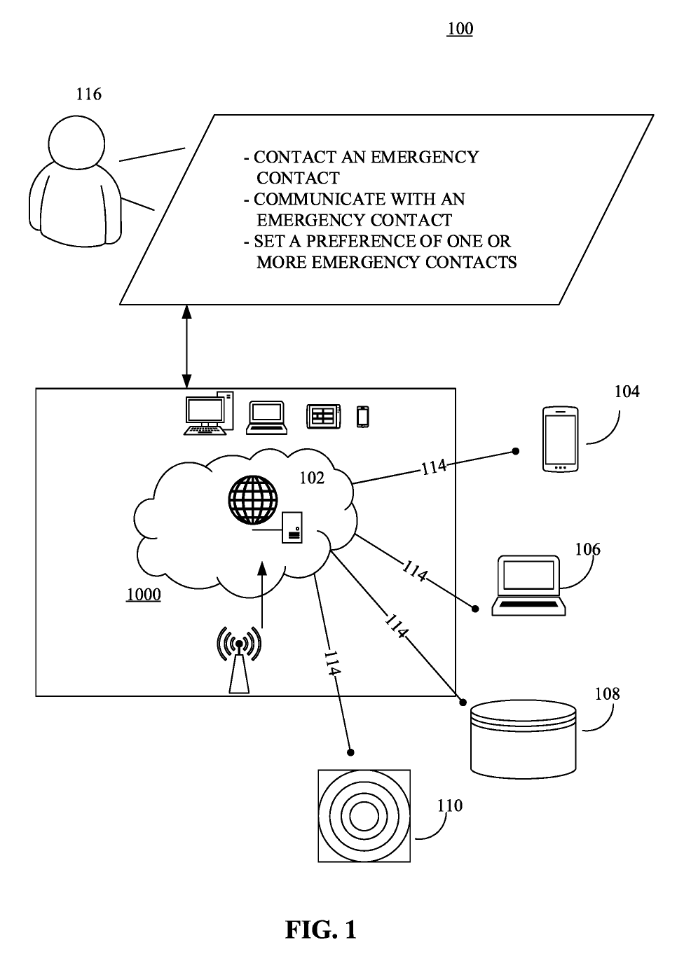

FIG. 1 is an illustration of an online platform 100 consistent with various embodiments of the present disclosure. By way of non-limiting example, the online platform 100 to facilitate automated contact with emergency services in case of an emergency may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, and sensors 110 and over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access online platform 100 through a web based software application or browser. The web based software application may be embodied as, for example, but not be limited to, a website, a web application, a desktop application, and a mobile application compatible with a computing device 1000.

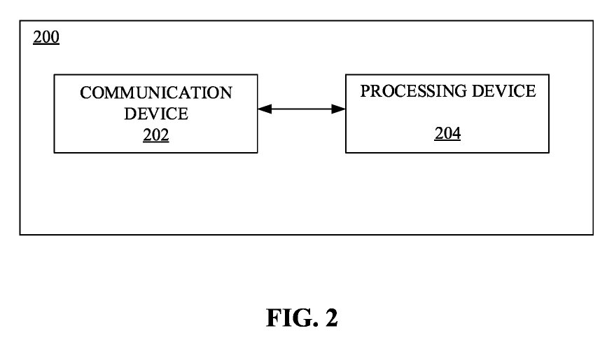

FIG. 2 is a block diagram of a system 200 to facilitate automated contact with emergency services in case of an emergency. Further, the system 200 may include a communication device 202 configured for receiving at least one of an emergency indicator, and a distress input from a first user device. Further, the distress input may include at least one of a tap, a knock, and a voice based input. Further, in an embodiment, the first user device may include a wearable user device, such as a smartwatch. Further, some embodiments, the first user device may include a wearable fitness band configured to monitor one or more physical parameters such as movement, posture, position, and so on, and physiological parameters, such as heart rate, rate of breathing, sleep activity, and so on. Further, the communication device 202 may be configured for transmitting a request to a second user device for initiating communication with at least one emergency contact.

Further, the second user device may include an electronic device, including, but not limited to a smartphone, a mobile device, a tablet computer, and so on configured to initiate communication with at least one emergency contact of the user. Further, the second user device may be configured to initiate the communication with the at least one emergency contact through at least one of a phone call, a text message, and a video call.

Further, the at least one emergency contact of the user may include at least one of a caretaker or caregiver of the user (if the user is an elderly citizen), a personal attendant or nurse of the user, a family member of the user, and emergency services, such as 911 emergency services.

Further, the system 200 may include a processing device 204 configured for analyzing the at least one of the emergency indicator, and the distress input to determine an emergency situation.

Further, in some embodiments, the at least one of the emergency indicator, and the distress input may be obtained from one or more sensors associated with the first user device. Further, in an embodiment, the emergency indicator may include sensory data obtained from one or more sensors associated with the first user device. For instance, the first user device may include an accelerometer, and a gyroscope configured to monitor a position, a posture, and a movement of the user. Further, in an instance, the first user device may include one or more physiological sensors to measure physiological parameters related to the user, such as a heart rate monitor configured to monitor a heart rate and a pulse of the user, a thermometer configured to measure body temperature of the user, and so on. Further, the distress input may correspond to an interaction of the user with the first user device, such as pressing an alarm button on the first user device or touching an emergency call button on a touch-based user interface of the first user device (if the user device is a touch-based device), or knocking the first user device against a solid surface. Further, the processing device 204 may be configured to analyze the emergency indicator, and determine an indication of an emergency situation. For instance, the processing device 204 may be configured to analyze sensory data obtained from the accelerometer, and the gyroscope to determine that the user may have fallen. Further, in an instance, the processing device 204 may be configured to analyze sensory data obtained from the one or more physiological sensors, such as the heart rate monitor, to determine if the user may be having a heart attack. Further, in an embodiment, the processing device 204 may be configured to analyze the distress input, such as analyzing and determining that the distress input may have been received just after the indication of the emergency situation determined based on the analyzing of the emergency indicator to determine an emergency situation.

Further, in some embodiments, the communication device 202 may be configured for initiating a communication with a first emergency contact in the at least one emergency contact. Further, the communication device 202 may be configured for initiating a communication with a second emergency contact in the at least one emergency contact. Further, the processing device 204 may be configured for determining a non-response from the first emergency contact. Further, the processing device 204 may be configured to analyze the communication with the first emergency contact, such as a phone call placed to the first emergency contact. Further, the processing device 204 may be configured the analyze the phone call, such as a call tone associated with the phone call Further, the processing device 204 may be configured to determine a non-response from the first emergency contact if a communication stream corresponding to the first emergency contact, such as a voice reply, or a reply of a text is not received from the first emergency contact within a pre-determined amount of time. Further, based on the analyzing, the communication device 202 may be configured to initiate a communication with the second emergency contact if a response is not received from the first emergency contact.

Further, in some embodiments, the communication device 202 may be configured for receiving a preference order of the at least one emergency contact from at least one of the first user device and the second user device. Further, the preference order may include a list of one or more emergency contacts of the at least one emergency contact arranged in descending order of preference. Further, the communication device 202 may be configured for initiating a communication with the one or more emergency contacts of the at least one emergency contacts based on the order preference order.

Further, in some embodiments, the communication device 202 may be configured for transmitting the communication request to the first user device for initiating a communication with the at least one emergency contact. Further, the first user device may be configured for initiating the communication with the at least one emergency contact based on the initiating the communication, such as through at least one of a voice call, a video call, and a text message to the at least one emergency contact.

Further, in some embodiments, the request may include a control instruction for the second user device to facilitate contact of the user with the at least one emergency contact. Further, in an instance, the at least one control instruction may include changing a mode of the second user device while initiating the second user device. For instance, if the second user device is configured to initiate the communication with the at least one emergency contact through a phone call, the control instruction may include turning the second user device to a loudspeaker mode to allow the user to successfully communicate with the at least one emergency contact without having to physically handle the second user device.

Further, in some embodiments, the communication device 202 may be configured for transmitting a request to the second user device for initiating a communication with one or more emergency contacts in the at least one emergency contact associated with the user simultaneously. For instance, the communication device 202 may be configured to initiate communication with a plurality of emergency contacts of the at least one emergency contact, such as through a conference call, or a chain text message.

Further, in some embodiments, the system 200 may include a storage device configured for storing a pre-recorded message. Further, the communication device 202 may be configured for receiving the pre-recorded message from at least one of the first user device and the second user device, when the user may be unable to communicate with the at least one emergency contact. Further, the pre-recorded message may include a distress message, such as including a name, age, gender, and potential location of the user. For instance, the pre-recorded message may include a voice-note with including a name, age, gender, and potential location of the user. Further, the pre-recorded message may include a text message including a name, age, gender, and potential location of the user.

Further, in some embodiments, the communication device 202 may be configured for transmitting a second request to the second user device for initiating communication with the at least one emergency contact. Further, the communication device 202 may be configured for transmitting the pre-recorded message to the at least one emergency contact associated with the user. Further, the processing device 204 may be configured for analyzing a user communication stream associated with the communication to determine an inability of the user to communicate with the at least one emergency contact. Further, in an embodiment, the second request may be transmitted to the second user device after transmitting the request to the second user device. Further, the processing device 204 may be configured to analyze a communication stream, or absence thereof, to determine the inability of the user to communicate with the at least one emergency contact. For instance, upon initiating the communication, such as a phone call, the processing device 204 may be configured to analyze a voice of the user while talking on the phone call with the at least one emergency contact. Further, the communication stream, such as the voice of the user may be analyzed to determine if the user is able to communicate with the at least one emergency contact. Further, if the communication stream does not include the voice of the user, or includes sounds corresponding to pain, such the processing device 204 may determine the inability of the user to communicate with the at least one emergency contact. Thereupon, the pre-recorded message may be transmitted to the at least one emergency contact.

Further, in some embodiments, the communication device 202 may be configured for receiving a sensory data from the first user device. Further, the storage device may be configured for storing the sensory data. Further, the sensory data may be associated with the pre-recorded message. Further, in an embodiment, the sensory data may be obtained from a sensor of the first user device. Further, the sensory data may include one or more of a location of the user or physiological parameters associated with the user, such as body temperature, heart rate, rate of breathing, and so on. Further, the sensory data may be associated with the pre-recorded message. Further, in an embodiment, the sensory data may be transmitted to the at least one emergency contact along with the pre-recorded message.

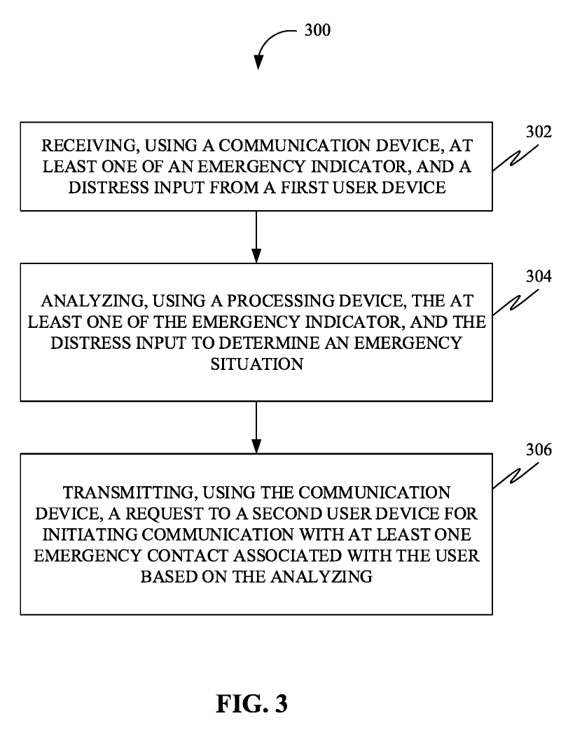

FIG. 3 is a flowchart of a method 300 to facilitate automated contact with emergency services in case of an emergency, in accordance with some embodiments. Further, at 302, the method 300 may include receiving, using a communication device, such as the communication device 202, at least one of an emergency indicator, and a distress input from a first user device. Further, the distress input may include at least one of a tap, a knock, and a voice based input.

Further, at 304, the method 300 may include analyzing, using a processing device, such as the processing device 204, the at least one of the emergency indicator, and the distress input to determine an emergency situation.

Further, at 306, the method 300 may include transmitting, using the communication device, a request to a second user device for initiating communication with at least one emergency contact associated with the user based on the analyzing.

Further, in some embodiments, the at least one of the emergency indicator, and the distress input may be obtained from one or more sensors associated with the first user device.

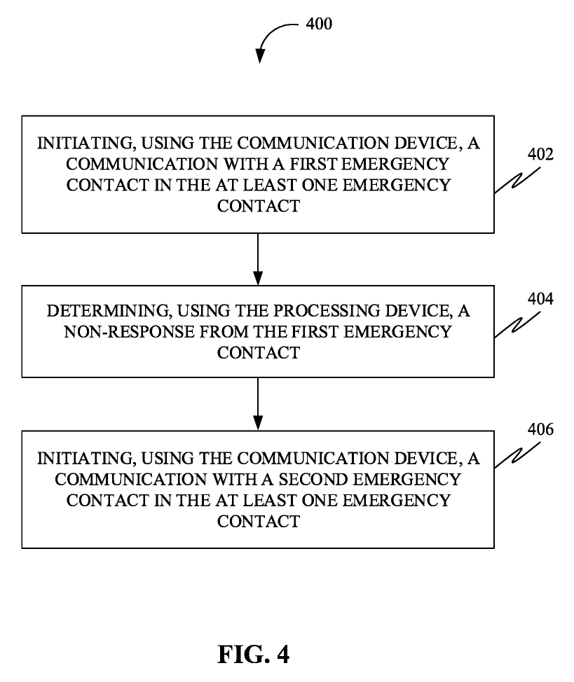

FIG. 4 is a flowchart of a method 400 to facilitate automated communication with a second emergency contact, in accordance with some embodiments. Further, at 402, the method 400 may include initiating, using the communication device, a communication with a first emergency contact in the at least one emergency contact.

Further, at 404, the method 400 may include determining, using the processing device, a non-response from the first emergency contact.

Further, at 406, the method 400 may include initiating, using the communication device, a communication with a second emergency contact in the at least one emergency contact.

Further, in some embodiments, the method 400 may include receiving, using the communication device, a preference order of the at least one emergency contact from at least one of the first user device and the second user device.

Further, in some embodiments, the method 400 may include transmitting, using the communication device, the communication request to the first user device for initiating a communication with the at least one emergency contact.

Further, in some embodiments, the request may include a control instruction for the second user device to facilitate contact of the user with the at least one emergency contact.

Further, in some embodiments, the method 400 may include transmitting, using the communication device, a request to the second user device for initiating a communication with one or more emergency contacts in the at least one emergency contact associated with the user simultaneously.

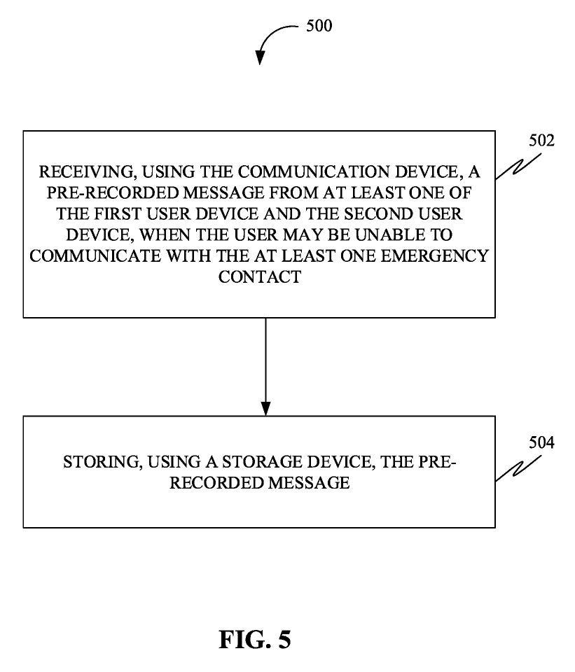

FIG. 5 is a flowchart of a method 500 to facilitate receiving a pre-recorded message, in accordance with some embodiments. Further, at 502, the method 500 may include receiving, using the communication device, a pre-recorded message from at least one of the first user device and the second user device, when the user may be unable to communicate with the at least one emergency contact.

Further, at 504, the method 500 may include storing, using a storage device, the pre-recorded message.

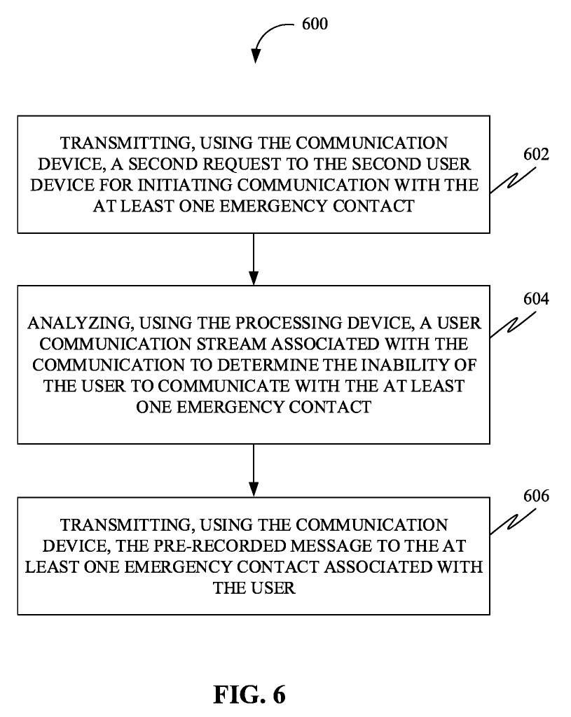

FIG. 6 is a flowchart of a method 600 to facilitate transmitting the pre-recorded message to the at least one emergency contact, in accordance with some embodiments.

Further, at 602, the method 600 may include transmitting, using the communication device, a second request to the second user device for initiating communication with the at least one emergency contact.

Further, at 604, the method 600 may include analyzing, using the processing device, a user communication stream associated with the communication to determine an inability of the user to communicate with the at least one emergency contact.

Further, at 606, the method 600 may include transmitting, using the communication device, the pre-recorded message to the at least one emergency contact associated with the user.

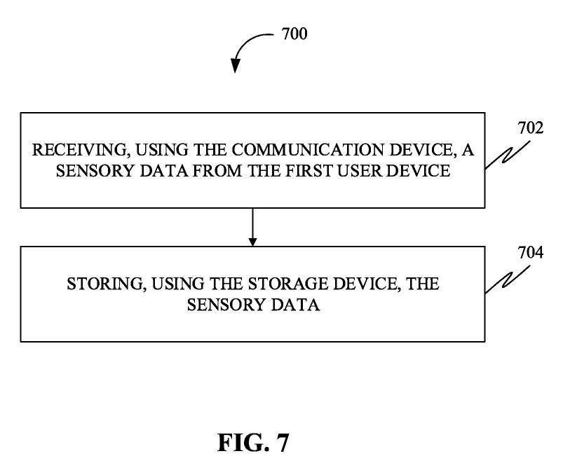

FIG. 7 is a flowchart of a method 700 to facilitate receiving a sensory data associated with the pre-recorded message, in accordance with some embodiments. Further, at 702, the method 700 may include receiving, using the communication device, a sensory data from the first user device.

Further, at 704, the method 700 may include storing, using the storage device, the sensory data, wherein the sensory data is associated with the pre-recorded message.

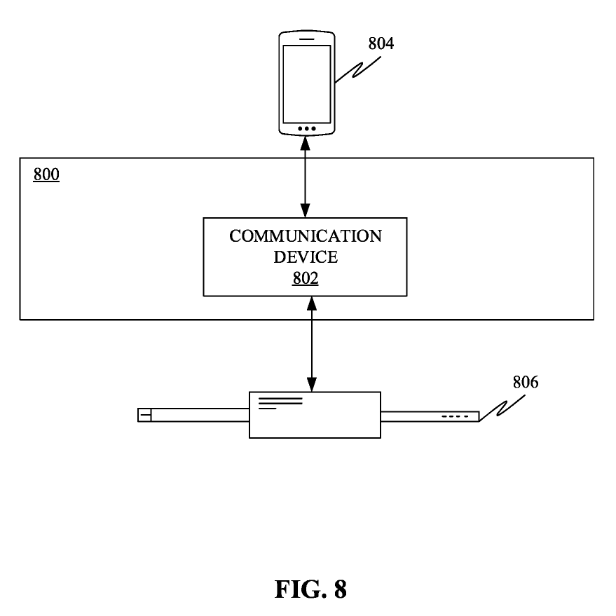

FIG. 8 is a system 800 to facilitate making a call from a phone 804 to a pre-programmed number in response to at least one of tapping and knocking of a wristband 806 paired with the phone 804 in case of an emergency, in accordance with some embodiments. Further, the system 800 may include a communication device 802 configured for receiving indication of the at least one of the tapping and the knocking from the paired wristband 806. Further, in some embodiments, the indication of the at least one of the tapping and the knocking may be obtained from one or more sensors associated with the paired wristband 806. Further, in an embodiment, the indication of the at least one of the tapping and the knocking may include sensory data obtained from one or more sensors associated with the paired wristband 806. For instance, the paired wristband 806 may include an accelerometer, and a gyroscope configured to monitor a position, a posture, a tapping of the paired wristband 806, a knocking of the paired wristband 806, and a movement of a user, and such as an elderly citizen. Further, the communication device 802 may be configured for transmitting a request to the phone 804, wherein the request comprises making the call to the pre-programmed number.

Further, in some embodiments, the request may include an instruction to the phone 804 to switch on a loudspeaker mode while making the call to the pre-programmed number.

Further, in some embodiments, the communication device 802 may be configured for transmitting a request to the phone 804. Further, the second request may include transmitting a text message to the pre-programmed number.

Further, in some embodiments, the system 800 may include a processing device. Further, the processing device may be configured for converting the text message to a voice message. Further, the voice message may include a name of a caller, a location of the caller, and a situation of the caller, wherein the text message may be transmitted to a 911 dispatcher.

Further, in an embodiment, the paired wristband 806 may include a smartwatch with a phone capability, and may be configured to make the call to the pre-programmed phone number.

Further, in an embodiment, the paired wristband 806 may include a smartwatch with a phone capability, and may be configured to send the text message to the pre-programmed phone number.

Further, in an embodiment, the communication device 802 may be configured to transmit a signal, such as a haptic vibration signal to the paired wristband 806 to confirm a successful transmission of the text message to the preprogrammed phone number.

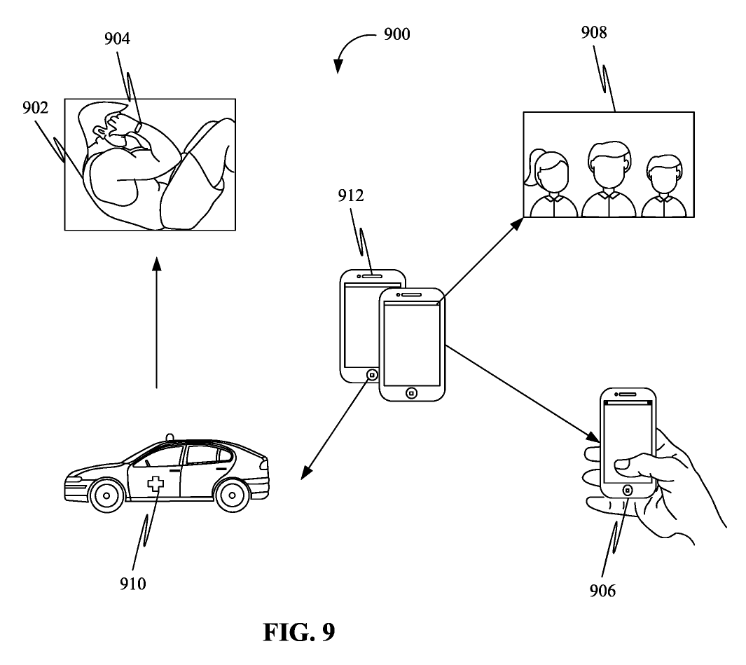

FIG. 9 is an exemplary representation of a system 900 to facilitate automated contact with emergency services in case of an emergency. Further, when a user 902 falls down, and taps a wristband 904, or knocks the wristband 904 against the floor or wall, an accelerometer in the wristband may generate spikes of acceleration force, which may be analyzed by the system Further, the system 900 may send an emergency call request message to a phone 912 of the user 902 (such as the second user device) over a communication network, such as Bluetooth or NFC. Further, the phone 912 of the user 902 may be switched to a loudspeaker mode and may make an announcement of call initiation. Further, the call may be placed to an emergency contact, such as a caregiver 906. If the caregiver 906 is unable to answer the phone, a second call may be place to a second emergency contact, such as to one or more family members 908. Further, a call may be placed to a 911 emergency dispatcher 910. In an embodiment, the system 900 may transmit a preprogrammed message with a name, location and a situation of the user 902 to one or more for the emergency contacts, such as the 911 emergency dispatcher 910.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

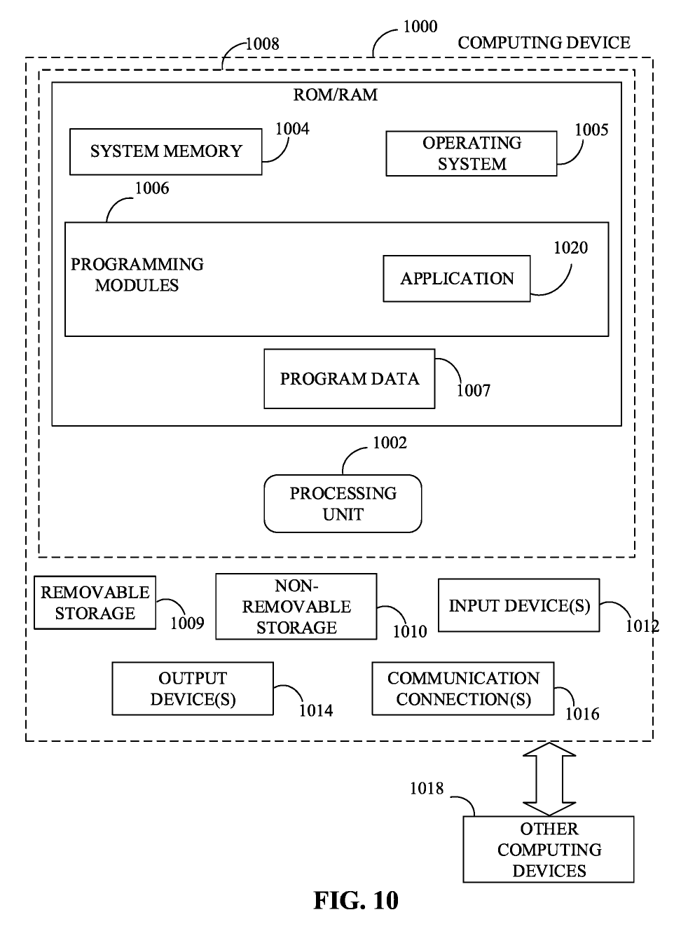

With reference to FIG. 10, a system consistent with an embodiment of the disclosure may include a computing device or cloud service, such as computing device 1000. In a basic configuration, computing device 1000 may include at least one processing unit 1002 and a system memory 1004. Depending on the configuration and type of computing device, system memory 1004 may comprise, but is not limited to, volatile (e.g. random-access memory (RAM)), non-volatile (e.g. read-only memory (ROM)), flash memory, or any combination. System memory 1004 may include operating system 1005, one or more programming modules 1006, and may include a program data 1007. Operating system 1005, for example, may be suitable for controlling computing device 1000's operation. In one embodiment, programming modules 1006 may include image-processing module, machine learning module. Furthermore, embodiments of the disclosure may be practiced in conjunction with a graphics library, other operating systems, or any other application program and is not limited to any particular application or system. This basic configuration is illustrated in FIG. 10 by those components within a dashed line 1008.

Computing device 1000 may have additional features or functionality. For example, computing device 1000 may also include additional data storage devices (removable and/or non-removable) such as, for example, magnetic disks, optical disks, or tape. Such additional storage is illustrated in FIG. 10 by a removable storage 1009 and a non-removable storage 1010. Computer storage media may include volatile and non-volatile, removable and non-removable media implemented in any method or technology for storage of information, such as computer-readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1000. Any such computer storage media may be part of device 1000. Computing device 1000 may also have input device(s) 1012 such as a keyboard, a mouse, a pen, a sound input device, a touch input device, a location sensor, a camera, a biometric sensor, etc. Output device(s) 1014 such as a display, speakers, a printer, etc. may also be included. The aforementioned devices are examples and others may be used.

Computing device 1000 may also contain a communication connection 1016 that may allow device 1000 to communicate with other computing devices 1018, such as over a network in a distributed computing environment, for example, an intranet or the Internet. Communication connection 1016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1004, including operating system 1005. While executing on processing unit 1002, programming modules 1006 (e.g., application 1020 such as a media player) may perform processes including, for example, one or more stages of methods, algorithms, systems, applications, servers, databases as described above. The aforementioned process is an example, and processing unit 1002 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM.

Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method to facilitate automated contact with emergency services in case of an emergency, the method comprising:
receiving, using a communication device, at least one of an emergency indicator, and a distress input from a first user device, wherein the distress input comprises at least one of a tap, a knock, and a voice based input;
analyzing, using a processing device, the at least one of the emergency indicator, and the distress input to determine an emergency situation; and
transmitting, using the communication device, a request to a second user device for initiating communication with at least one emergency contact associated with the user based on the analyzing.

2. The method of claim 1, wherein the at least one of the emergency indicator, and the distress input is obtained from one or more sensors associated with the first user device.

3. The method of claim 1 further comprising
initiating, using the communication device, a communication with a first emergency contact in the at least one emergency contact;
determining, using the processing device, a non-response from the first emergency contact; and
initiating, using the communication device, a communication with a second emergency contact in the at least one emergency contact.

4. The method of claim 1 further comprising:
receiving, using the communication device, a pre-recorded message from at least one of the first user device and the second user device, when the user is unable to communicate with the at least one emergency contact; and
storing, using a storage device, the pre-recorded message.

5. The method of claim 4 further comprising:
transmitting, using the communication device, a second request to the second user device for initiating communication with the at least one emergency contact;
analyzing, using the processing device, a user communication stream associated with the communication to determine an inability of the user to communicate with the at least one emergency contact; and
transmitting, using the communication device, the pre-recorded message to the at least one emergency contact associated with the user.

6. The method of claim 4 further comprising;
receiving, using the communication device, a sensory data from the first user device; and
storing, using the storage device, the sensory data, wherein the sensory data is associated with the pre-recorded message.

7. The method of claim 1, wherein the request further comprises a control instruction for the second user device to facilitate contact of the user with the at least one emergency contact.

8. The method of claim 1 further comprising transmitting, using the communication device, a request to the second user device for initiating a communication with one or more emergency contacts in the at least one emergency contact associated with the user simultaneously.

9. A system to facilitate automated contact with emergency services in case of an emergency, the system comprising:
a communication device configured for:
receiving at least one of an emergency indicator, and a distress input from a first user device, wherein the distress input comprises at least one of a tap, a knock, and a voice based input; and
transmitting a request to a second user device for initiating communication with at least one emergency contact; and
a processing device configured for analyzing the at least one of the emergency indicator, and the distress input to determine an emergency situation.

10. The system of claim 9, wherein the at least one of the emergency indicator, and the distress input is obtained from one or more sensors associated with the first user device.

11. The system of claim 9, wherein:
the communication device is further configured for:
initiating a communication with a first emergency contact in the at least one emergency contact; and
initiating a communication with a second emergency contact in the at least one emergency contact; and
the processing device is further configured for determining a non-response from the first emergency contact.

12. The system of claim 9 further comprising a storage device configured for storing a pre-recorded message, wherein the communication device is further configured for receiving the pre-recorded message from at least one of the first user device and the second user device, when the user is unable to communicate with the at least one emergency contact.

13. The system of claim 12, wherein:
the communication device is further configured for:
transmitting a second request to the second user device for initiating communication with the at least one emergency contact; and
transmitting the pre-recorded message to the at least one emergency contact associated with the user; and
the processing device is further configured for analyzing a user communication stream associated with the communication to determine an inability of the user to communicate with the at least one emergency contact.

14. The system of claim 12, wherein:
the communication device is further configured for receiving a sensory data from the first user device; and
the storage device is further configured for storing the sensory data, wherein the sensory data is associated with the pre-recorded message.

15. The system of claim 9, wherein the request further comprises a control instruction for the second user device to facilitate contact of the user with the at least one emergency contact.

16. The system of claim 9, wherein the communication device is further configured for transmitting a request to the second user device for initiating a communication with one or more emergency contacts in the at least one emergency contact associated with the user simultaneously.

17. A system to facilitate making a call from a phone to a pre-programmed number in response to at least one of tapping and knocking of a wristband paired with the phone in case of an emergency, the system comprising:
a communication device configured for:
receiving indication of the at least one of the tapping and the knocking from the paired wristband; and
transmitting a request to the phone, wherein the request comprises making the call to the pre-programmed number.

18. The system of claim 17, wherein the request comprises an instruction to the phone to switch on a loudspeaker mode while making the call to the pre-programmed number.

19. The system of claim 17, wherein the communication device is configured for transmitting a second request to the phone, wherein the request comprises transmitting a text message to the pre-programmed number.

20. The system of claim 17 further comprising a processing device configured for converting the text message to a voice message comprising a name of a caller, a location of the caller, and a situation of the caller, wherein the text message may be transmitted to a 911 dispatcher.
